(19) United States
(12) Patent Application Publication
(10) Pub. No.: US 2003/0026873 A1
(43) Pub. Date: Feb. 6, 2003

(54) Method for decorating edible substrates with pellet shaped candy pieces

(76) Inventors: Thomas M. Collins, Nazareth, PA (US); James M. Suttle, East Stroudsburg, PA (US); Neil A. Willcocks, Flanders, NJ (US)

Correspondence Address: FITZPATRICK CELLA HARPER & SCINTO, 30 ROCKEFELLER PLAZA, NEW YORK, NY, 10112, US

(21) Appl. No.: 09/919,961

(22) Filed: Aug. 2, 2001

(51) Int. Cl. A23L 1/00

(52) U.S. Cl. 426/87

(57) ABSTRACT

A method is disclosed for preparing an edible substrate such as a chocolate tablet having pellet shaped candy pieces arranged on the surface thereof in a predetermined defined pattern. Also disclosed is a novel chocolate confectionery prepared by the disclosed method and an apparatus for practicing the method.

### BACKGROUND OF THE INVENTION

1. Field of the Invention

This invention is directed to a method for decorating a surface of an edible substrate with a pattern of pellet shaped candy pieces. Exemplary edible substrates include confectionery and baked goods. A particularly preferred edible substrate is a chocolate tablet.

2. Related Background Art

Edible substrates, such as confectionery and baked goods, decorated with candy pieces have long been desired. It is known to decorate baked goods by hand placement of candy pieces in a defined pattern. A method that would provide a means of mass producing edible substrates with a defined pattern of candy pieces on a surface thereof would be quite advantageous.

Moreover, there has been an increasing demand for chocolate novelty products. For example, the availability of chocolate products taking the shape of cartoon characters or holiday symbols have increased in recent years. There is however, a continuing desire to provide consumers with additional novelty chocolate products.

In particular, a chocolate tablet having pellet shaped candy pieces affixed thereto in a defined pattern would be highly desirous. While such a product could be prepared by hand placing pellet shaped candy pieces with an edible glue on a chocolate surface, this technique would hardly be sufficient for the mass production of such chocolate novelty products.

### SUMMARY OF THE INVENTION

This invention is directed to a method for decorating a surface of an edible substrate with a defined pattern of pellet shaped candy pieces. The edible substrates useful in this invention include confectionery and baked goods. Exemplary baked goods include cookies and cup cakes. Exemplary confectionery goods include substantially flat lollipops or chocolate tablets. The most preferred edible substrate of this invention is a chocolate tablet.

The method includes the steps of introducing a plurality of pellet shaped candy pieces to a hopper mounted on a conveyor, with the conveyor having a plurality of carrier bars. At least one group of the plurality of carrier bars has pockets for receiving the pellet shaped candy pieces wherein the pockets in the group of carrier bars are arranged to form a predetermined defined pattern. The pellet shaped candy pieces are received in the pockets and then transported by the conveyor to a transfer station. At the transfer station the group of pellet shaped candy pieces defining the predetermined pattern are transferred from the pockets to the surface of a chocolate tablet and affixed thereto in the predetermined pattern.

Another embodiment of this invention is directed to an apparatus for performing the method of this invention. Yet another embodiment of this invention is directed to a decorated chocolate tablet prepared by the method of this invention.

### BRIEF DESCRIPTION OF THE DRAWINGS

FIG. 1 illustrates a ramp style conveyor system used in the method of this invention.

FIG. 2 illustrates a plurality of carrier bars consisting of several groupings of carrier bars having pockets for receiving pellet shaped candy pieces in a predetermined defined pattern.

FIG. 3 illustrates a transfer station used for transferring shaped candy pieces from a ramp conveyor system to chocolate tablets while maintaining the predetermined defined pattern of the candy pieces achieved by the conveyor system.

FIG. 4 illustrates a drum style conveyor system used in the method of this invention.

FIG. 5 illustrates another view of the drum style conveyor system used in the method of this invention.

FIG. 6 illustrates a cross sectional view of a carrier bar having pockets for receiving pellet shaped candy pieces with each pocket having a vacuum communicating outlet.

FIG. 7 illustrates a heart shaped chocolate product framed with M&M's® Brand candy pieces that is prepared by the method of this invention.

### DETAILED DESCRIPTION OF THE INVENTION

The edible substrate that may be decorated by the method of this invention may be of any shape. For example, the substrate may be in the shape of a rectangle, square, heart, circle, triangle, cartoon character, and the like. The surface of the edible substrate that is decorated with the pellet shaped candy pieces is generally substantially planar, but could be a non-planar surface. Substantially planar surfaces include those having raised ridges or areas of edible material, as well as recesses, and that term is used herein simply to designate the general plane of the upper surface of the edible substrate.

For example, a chocolate tablet used herein as an edible substrate may have a raised ridge of chocolate surrounding the perimeter of the tablet forming a frame of raised chocolate. Similarly, the chocolate tablets used herein may also contain molded features of an ornamental design such as cartoon characters or holiday symbols.

The chocolate tablet used in this invention may be standard of identity (SOI) chocolate or non-SOI chocolate. The chocolate tablets used in this invention preferably will contain recesses on the upper surface thereof that are arranged in the shape of the predetermined defined pattern. The recesses are designed to assist in receiving and seating the pellet shaped candy pieces. Such recesses are readily formed when the chocolate tablet is molded.

The pellet shaped candy pieces are preferably spherical or lentil shaped pieces, such as “M&M's®” Brand Chocolate Candies or “SKITTLES®” Bite Size Candies. Other candy pieces that may be used in this invention include jellybeans, sugar drops, cinnamon drops and the like. Preferably, the candy pieces used in the method of this invention are sugar shelled candy pieces having a lenticular shape.

If desired, the candy pieces may be arranged and set to a predetermined depth on the chocolate tablet to provide protection to at least a portion of the surface of the chocolate tablet. For example, one may want to protect the portion of the surface of a chocolate tablet having an image formed thereon from potential damage due to package abrasion during transport.

The method of this invention is performed using a conveyor system with a hopper mounted thereto.

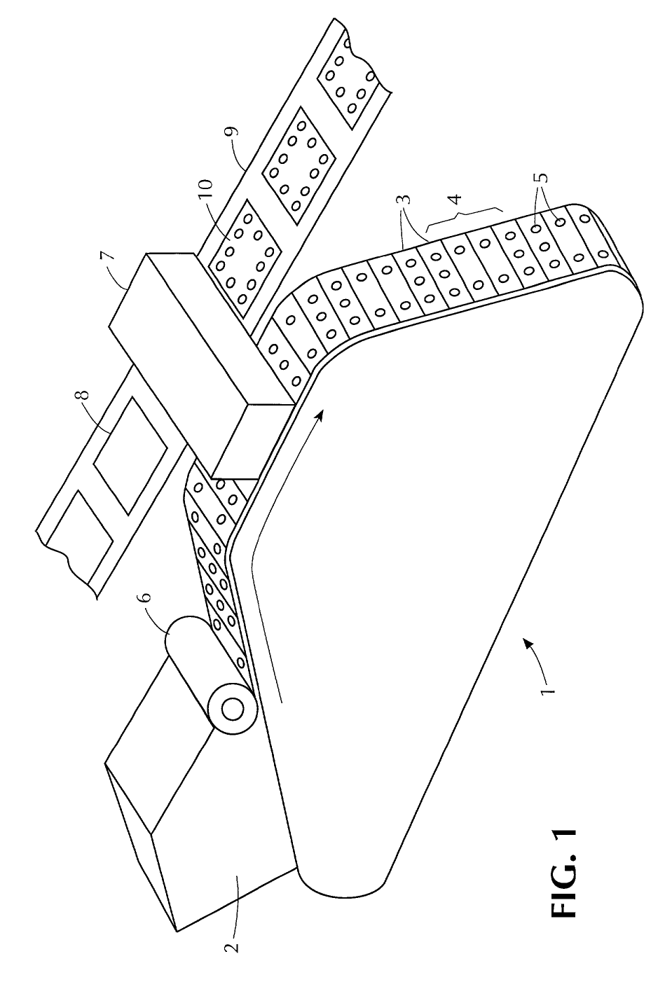

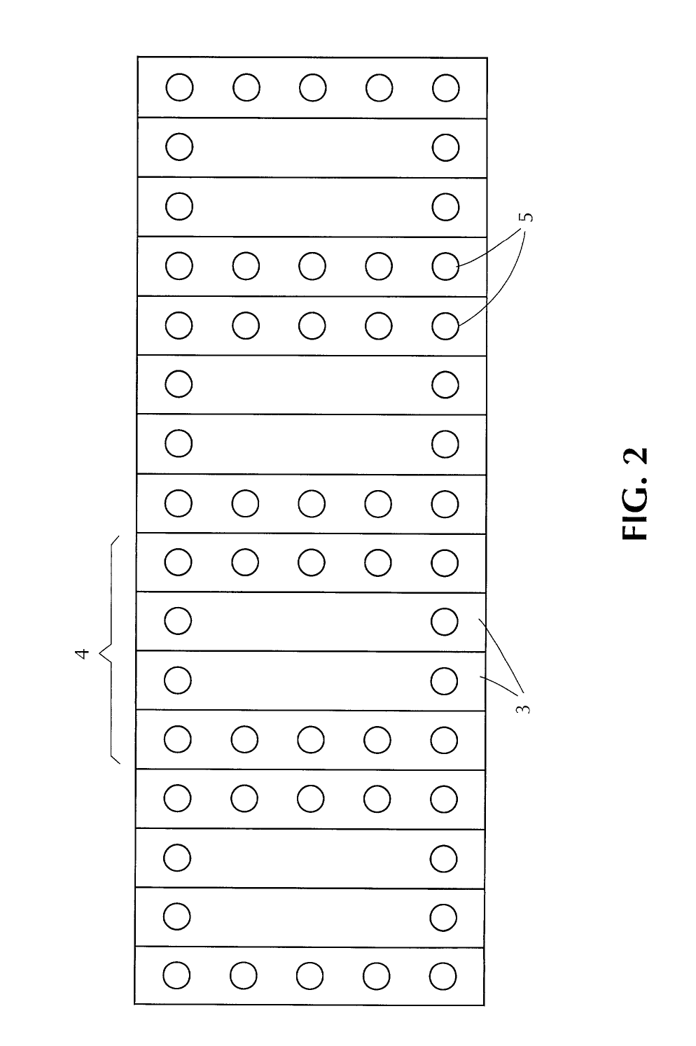

FIG. 1 illustrates a ramp style conveyor 1 with a hopper 2. A plurality of carrier bars 3 makes up the conveying surface which forms a continuous loop that is mechanically driven. There is at least one grouping of carrier bars 4 having pockets 5 for receiving pellet shaped candies that are introduced into the hopper 2. Significantly, the carrier bars 3 in each grouping 4 are arranged in a manner so that the pockets 5 form a predetermined defined pattern. For example, FIG. 2 illustrates an arrangement of carrier bars in a grouping 4 wherein the pockets 5 form rectangular patterns.

As used herein, predetermined defined pattern means that the pattern is not a random pattern but in fact is defined and predetermined by the position of the pockets 5 for receiving the pellet shaped candies. The predetermined defined pattern may be of any design. For example, the pattern may frame the edible substrate being decorated or form the shape of a character or symbol. The pattern is controlled by using an arrangement of carrier bars having pockets 5 in the requisite positions to form the desired pattern. The pattern need not be ordered, but is predefined by the location of the pockets. The defined pattern may be a linear, but not necessarily straight, pattern which may be a continuous linear pattern, e.g., rectangle, circle or heart, or discontinuous linear pattern, e.g., alphanumeric symbols. As used herein, linear is meant to define a pattern of candies formed from one or more lines which may be straight and/or curved and which may or may not intersect.

The method of the invention is practiced by first introducing a plurality of pellet shaped candy pieces to the hopper 2. The conveying surface moves beneath the hopper on an incline. This causes pellet shaped candy pieces to fill the pockets 5 for receiving the pellet shaped candies as the carrier bars 3 move beneath the hopper. Roller or preferably brush 6 assists in allowing only pellet shaped candy pieces that have filled the pockets 5 to continue up the ramp incline as the carrier bars exit the hopper. Such ramp style conveying systems for pellet like particles are well known and are described for example in U.S. Pat. No. 5,655,453, the disclosure of which is incorporated by reference herein. Such conveying systems, however, have been previously used simply as mass conveyance systems and have not been used to create defined patterns for transfer to an edible substrate.

The patterns that may be defined by the pockets 5 of carrier bars 3 in a grouping 4 of carrier bars has been previously described. It will be apparent that the desired pattern can be achieved by arranging carrier bars 3 having pocket(s) 5 in an appropriate position so that when the carrier bars 3 are grouped together in grouping 4 the pattern is achieved. It should also be apparent that a desired pattern may be achieved by using one or more carrier bars 3 in a grouping 4 which have no pockets 5.

Certain spacing requirements for a discontinuous pattern, may be achieved by varying the relative speeds of the ramp conveyor and the transfer station/conveyor systems. For example, if 4 candies were to be placed, one each at the corners of a 5 inch×7 inch (12.7 cm×17.8 cm) chocolate tablet, one would not necessarily need to have one or more blank carrier bars in the carrier bar arrangement. These blank bars could be eliminated and the carrier bar movement appropriately slowed down to match the desired needs of the transfer/conveyor system.

Once the pellet shaped candy pieces have been received in pockets 5, they are conveyed to a transfer station 7, shown located at a horizontal position on the conveyor. The transfer station 7 is designed to pick up the pellet shaped candy piece from the pockets 5 and transfer those candy pieces to an edible substrate such as a chocolate tablet 8 that is transported along edible substrate conveyor 9 which is located proximate to ramp conveyor 1. As illustrated in FIG. 1 the chocolate conveyor 9 passes underneath transfer station 7 to facilitate the movement of the pellet shaped candy pieces from the ramp conveyor to the edible substrate (in this case chocolate tablet 8) on edible substrate conveyor 9 to produce a chocolate tablet decorated with pellet shaped candy pieces 10 in a defined pattern. While FIG. 1 illustrates a ramp type conveyor system and edible substrate conveyor system arranged parallel to one another, the decorating system could also be set up so that the ramp type conveyor and edible substrate conveyor system are perpendicular to one another.

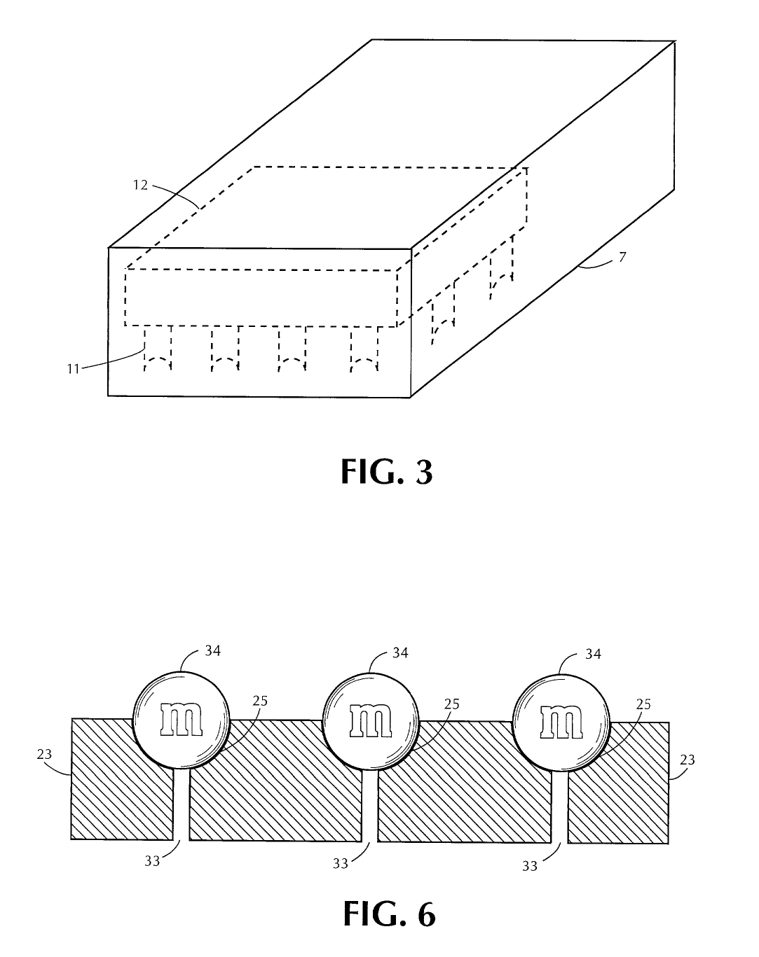

The transfer of the pellet shaped candy pieces from carrier bars 3 to an edible substrate such as chocolate tablets 8 is performed at transfer station 7 in any manner that maintains the defined pattern achieved by the grouping of carrier bars. FIG. 3 illustrates a preferred transfer station 7 having suction elements 11 protruding from slidable transfer block 12. The suction elements 11 are positioned on transfer block 12 to correspond to the pattern of candies held in a grouping 4 of carrier bars 3. As such, ramp conveyor 1 is synchronized to move a grouping 4 of pellet shaped candy pieces under transfer station 7, each pellet shaped candy piece being aligned with suction element 11. Once aligned, suction elements 11 are lowered onto the pellet shaped candy pieces and suction is applied. The suction elements 11 may be individually slidable or the transfer block 12 may be movable in a vertical direction to cause suction elements 11 to contact the candy pieces. Thus, when the suction elements are raised, pellet shaped candy pieces are removed from their respective pocket 5. Transfer block 12 is then slidably moved over edible substrate conveyor 9.

Synchronized with the delivery of an edible substrate such as chocolate tablet 8, the suction elements 11 are lowered and suction is discontinued to facilitate placing the pellet shaped candy pieces onto chocolate tablet 8 while maintaining the desired pattern. The synchronized movement of block 12, suction elements 11, ramp conveyor 1 and edible substrate conveyor 9 can be controlled mechanically or electronically.

When the edible substrate is the chocolate tablet 8, it preferably will have recesses for receiving the pellet shaped candy pieces. As noted previously the recesses will correspond to the predetermined defined pattern so that a pellet shaped candy piece is delivered to each recess in chocolate tablet 8. When suction elements 11 are lowered, this vertical motion may include positive downward force to help “seat” the candies securely on the edible substrate and more preferably into the recesses of the chocolate tablet.

In a preferred embodiment, transfer block 12 can be designed to have generic mounting sockets for the suction elements 11 arranged in a rectangular grid. Suction elements 11 can then be placed in the desired pattern in block 12 and the remaining unused sockets sealed off with plugs. This has the advantage of allowing the quick changeover of patterns without the need to create new suction element units for each new design. Alternatively, a suction element unit specific to a pattern could have a plate as base allowing at least quick change over to a new pattern.

The pellet shaped candy pieces delivered to the edible substrate such as chocolate tablet 8 are affixed thereto using an edible glue. Exemplary edible glue may be sugar syrup, corn starch, starch gum, chocolate and the like. When the edible substrate is a chocolate tablet, most preferably the edible glue is chocolate. The edible glue may be applied to the edible substrate prior to deposition of the pellet shaped candy pieces via an edible glue application station (not shown) located over the edible substrate conveyor 9 upstream of the transfer station 7. It will be apparent that the edible glue can be applied to the edible substrate in the same pattern as the pellet shaped candy pieces are to be applied. In a particularly preferred embodiment the edible glue is deposited into the above-described recesses in the chocolate tablet prior to deposition of the pellet shaped candy pieces in the recesses. It may also be desirable to employ a roller (not shown) down stream of the transfer station to assist in the adherence of the pellet shaped candy pieces to the chocolate tablet.

When the lentil shaped candies to be placed in a defined pattern have markings or decoration, such as the printed “m” on an “M&M's”® Chocolate Candies piece, it is desirable that all of the placed candies have the printed design showing. A preferred embodiment which achieves this effect involves the printing of “m”'s onto both sides of the candy piece in a manner described in U.S. Pat. No. 4,672,892. In this manner, with candies printed on both sides, the pieces may be loaded into the hopper and all placed candy pieces have the decoration showing and the desired finish effect of the product can be achieved. In a most preferred embodiment, decorated or marked lentil shaped candies wherein the decoration or marking has a particular proper orientation for viewing, will be arranged in a defined pattern such that all of the markings are showing on the exposed surface and are all oriented or registered in a defined manner.

This can be achieved by adding a transfer gravure printing station to the apparatus described prior to the transfer station 7. The printing station is ideally located over the carrier bars at a point where the carrier bars are moving on a horizontal plane similar to that described in U.S. Pat. No. 5,655,453. To achieve the desired effect, the engraved roll of the printing station will have the desired image etched into the roll in a pattern which corresponds to the pattern in which the lentils are to be placed onto the chocolate tablet. The etched roll picks up ink from an ink trough, is doctored clean, then contacts a transfer roll which picks up the ink and transfers the ink to the lentil shaped candies sitting in the defined pattern of pockets in the carrier bars. Thus, all of the candy pieces are printed just prior to being picked up from the carrier bars at the transfer station and because all of the printed pieces have printed images in alignment, the transferred candy pieces have printed images in alignment, the transferred candy pieces will also have aligned images. Obviously, if it is desirable to have the decorations on the candy pieces to be arranged in some other orientation, this can easily be achieved by this method by engraving the images in the desired orientation on the etch roll. For example, the “m”'s could alternately be angled at 30 degrees from the vertical on alternating pieces in the rectangular frame.

Another embodiment for adhering the candies to the chocolate tablet relies on partially softening the chocolate in the bottom of the cavity in the chocolate tablet designed to hold the candy. This can be achieved by introducing a very fine “spot” heat source into the cavity and warming the bottom surface of the cavity just prior to placing the candy. It is important to soften the surface and to not exceed a temperature of about 33° C. to about 35° C. in the chocolate to avoid detempering the chocolate, which could result in chocolate bloom. In a particularly preferred embodiment, the mold used to create the chocolate tablets will be modified to leave a small lump or nub of additional chocolate in the bottom of the cavity for the candy piece. In this embodiment, the spot heat source is used to soften this lump of chocolate which then acts as the edible glue to secure the candy to the chocolate tablet.

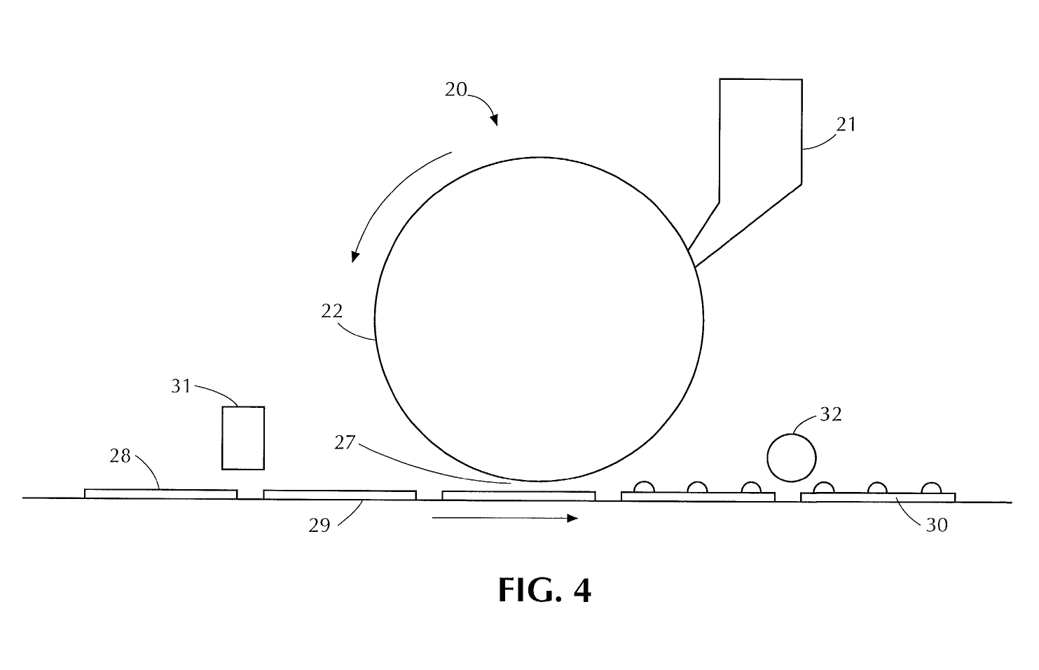

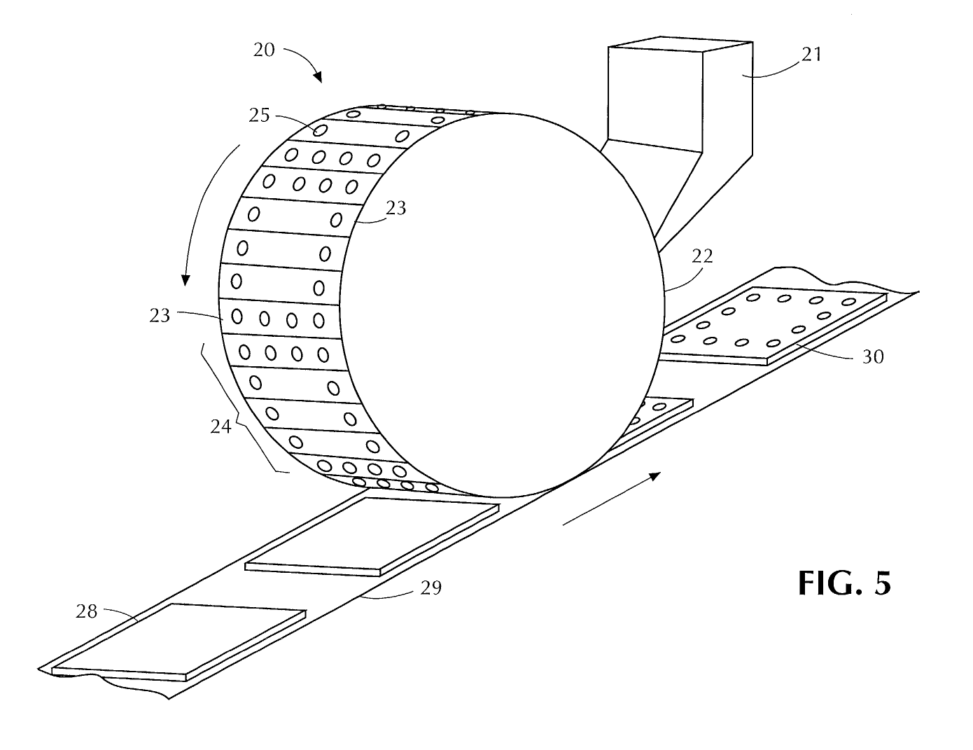

The method of this invention may also be practiced using a drum type conveyor system 20 such as illustrated in FIG. 4. In this system, hopper 21 is mounted on the inclined portion of drum 22 as shown in FIG. 4. Similar to the ramp type conveyor system previously described, the drum type conveyor as illustrated in FIG. 5, is comprised of a plurality of carrier bars 23 having pockets 25 for receiving the pellet shaped candy pieces. The carrier bars 23 are arranged in a grouping 24 so that the pockets 25 in the grouping form a predetermined defined pattern.

The drum 22 is designed so that the pellet shaped candy pieces that are picked up from the hopper in pockets 25 are subject to a vacuum. Referring to FIG. 6, this may be accomplished by including a vacuum communicating outlet 33 in each pocket 25 of carrier bar 23 and exposing that pocket to a vacuum from the interior of the drum at or after the hopper station so as to hold the pellet shaped candy piece 34 in the pocket 25 until it reaches the transfer release point 27. This can be readily achieved by isolating the interior of the drum from the vacuum source at the point where the transfer station is located.

An edible substrate conveyor 29 passes below the drum 22 in a manner that allows the pellet shaped candy pieces to be transferred from the receiving pockets 25 to the edible substrates such as chocolate tablets. As the drum 22 transports the pellet shaped candy pieces, the vacuum asserted on those pieces is discontinued as the pieces reach the chocolate tablet 28 that is to receive the pieces. The pellet shaped candy pieces thus fall out of the pockets 25 and preferably into a corresponding recess in chocolate tablet 28. This transfer may be assisted by applying a positive pressure to the inside of the drum in that region corresponding to the transfer release point 27. This results in a decorated chocolate tablet 30.

The drum type conveyor system is synchronized so that the pellet shaped candy pieces are matched with the corresponding recess in the chocolate tablet to form the decorated chocolate tablet. The drum type conveyor system may also include an edible glue station 31 that deposits an edible glue at the point at which the pellet shaped candy pieces are to be affixed to the chocolate tablet. The edible glue and the application thereof has been described in detail previously with respect to the ramp type conveyor system and is similarly applicable to the drum type conveyor system. Roller 32 may be employed if desired to assist in adhering the pellet shaped candy pieces to the chocolate tablet.

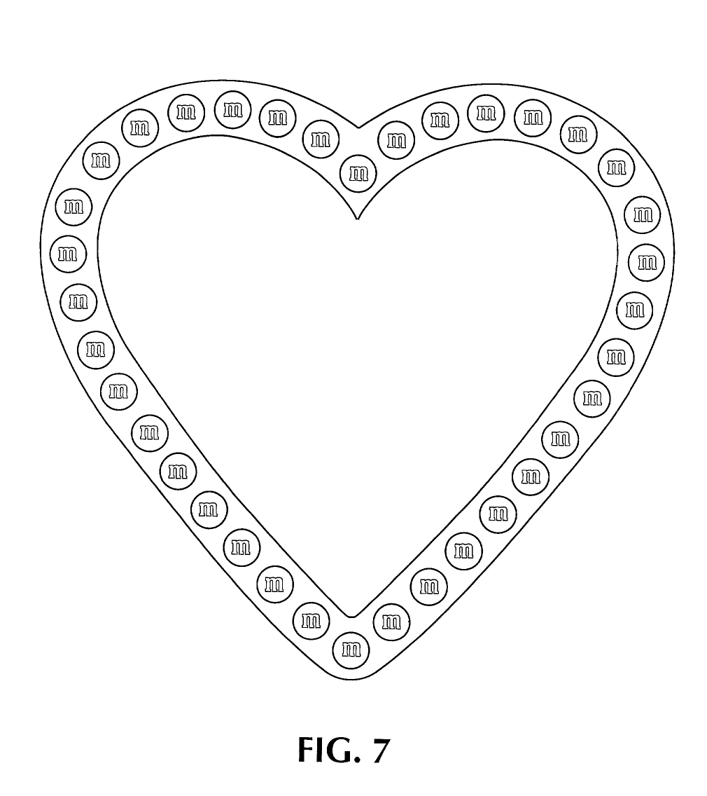

The method of this invention may be advantageously employed to prepare decorative chocolate tablets such as illustrated in FIG. 7.

While the method of this invention has been described in particularity with respect to a chocolate tablet, it should be apparent that the method may be applied to other edible substrates. Other variations and modifications of this invention will be obvious to those skilled in the art.

Another manner of obtaining an edible substrate with a defined pattern of candy pieces thereon would be to use a pick and place system. Such systems are well known. A pick and place system could be used to pick up candy pieces from a hopper or conveyor system. The conveyor need not have a predetermined defined pattern of receiving pockets since the candy pieces will be manipulated by the placement system and delivered to the edible substrate in a manner that results in a predetermined pattern of candy pieces on the edible substrate.

We claim:

1. A method for decorating a surface of an edible substrate with a defined pattern of pellet shaped candy pieces comprising the steps of:
(a) introducing a plurality of pellet shaped candy pieces to a hopper mounted on a conveyor, said conveyor having a plurality of carrier bars and wherein at least one grouping of said plurality of carrier bars has pockets for receiving the pellet shaped candy pieces and said pockets in said grouping of carrier bars are arranged to form a predetermined defined pattern;
(b) receiving the pellet shaped candy pieces in said pockets;
(c) transporting the pellet shaped candy pieces in said pockets to a transfer station; and
(d) transferring said pellet shaped candy pieces from said pockets to the surface of the edible substrate while maintaining said predetermined defined pattern and affixing said pellet shaped candy pieces to the surface of the edible substrate in said predetermined defined pattern.

2. The method according to claim 1, wherein said edible substrate is a confectionery or baked good and said surface of said substrate is substantially planar.

3. The method according to claim 1, wherein said edible substrate is a chocolate tablet.

4. The method according to claim 3, wherein the surface of said chocolate tablet has recesses for receiving said pellet shaped candy pieces and said recesses form a pattern corresponding to said predetermined pattern.

5. The method according to claim 4, wherein said pellet shaped candy pieces are affixed to said recesses with an edible glue.

6. The method according to claim 5, wherein said glue is selected from the group consisting of chocolate, sugar syrup, corn syrup, starch and gum.

7. The method according to claim 4, wherein each recess of said chocolate tablet contains a chocolate nub at a bottom of said recess and wherein each chocolate nub is heated to a temperature effective to cause said chocolate nubs to assist in securing said candy pieces in said recesses.

8. The method according to claim 1, wherein said conveyor is a ramp type conveyor.

9. The method according to claim 1, wherein said conveyor is a drum type conveyor.

10. The method according to claim 8, wherein said transfer station is comprised of suction elements for picking up and releasing said pellet shaped candy pieces and said suction elements are arranged in a pattern corresponding to said predetermined defined pattern.

11. The method according to claim 10, wherein said edible substrate is transported on an edible substrate conveyor proximate to said transfer station.

12. The method according to claim 9, wherein said pockets for receiving the pellet shaped candy pieces have a vacuum communicating outlet.

13. The method according to claim 12, wherein said drum conveyor is positioned above and proximate to an edible substrate conveyor system.

14. The method according to claim 13, wherein said transfer station is a point where said edible substrate conveyor system forms a tangent to said drum conveyor.

15. The method according to claim 14, wherein said pellet shaped candy pieces received in said pockets are subject to a vacuum and said vacuum is discontinued when said pellet shaped candy pieces reach said tangent.

16. The method according to claim 1, further comprising the step of printing an image on said pellet shaped candy pieces located in said pockets.

17. A chocolate tablet having a defined pattern of pellet shaped candy pieces on a surface thereof prepared by the process comprising the steps of:
(a) introducing a plurality of pellet shaped candy pieces to a hopper mounted on a conveyor, said conveyor having a plurality of carrier bars and wherein at least one grouping of said plurality of carrier bars has pockets for receiving the pellet shaped candy pieces and said pockets in said grouping of carrier bars are arranged to form a predetermined defined pattern;
(b) receiving the pellet shaped candy pieces in said pockets;
(c) transporting the pellet shaped candy pieces in said pockets to a transfer station; and
(d) transferring said pellet shaped candy pieces from said pockets to the surface of the chocolate tablet while maintaining said predetermined defined pattern and affixing said pellet shaped candy pieces to the surface of the chocolate tablet in said predetermined defined pattern.

18. An apparatus for decorating a surface of an edible substrate with a defined pattern of pellet shaped candy pieces, said apparatus comprising“
(a) a hopper for holding a plurality of pellet shaped candy pieces mounted on a conveyor, said conveyor having a plurality of carrier bars, wherein at least one grouping of said plurality of carrier bars has pockets for receiving the pellet shaped candy pieces and said pockets in said grouping of carrier bars are arranged to form a predetermined defined pattern;
(b) a transfer station positioned proximate to said conveyor for transferring said pellet shaped candy pieces from said pockets to the surface of the edible substrate while maintaining said predetermined defined patterns; and
(c) an edible substrate conveyor for delivering said edible substrates to said transfer station.

19. The apparatus according to claim 18, wherein said conveyor is a ramp type conveyor.

20. The apparatus according to claim 18, wherein said conveyor is a drum type conveyor.

21. The apparatus according to claim 18, wherein said transfer station is comprised of suction elements for picking up and releasing said pellet shaped candy pieces.

22. The apparatus according to claim 18, further comprising a printing station for printing on said pellet shaped candy pieces while positioned in said pockets.
